(19) United States
(12) Patent Application Publication
(10) Pub. No.: US 2021/0238063 A1
(43) Pub. Date: Aug. 5, 2021

(54) DEVICE AND PROCESS FOR CROSSFLOW MEMBRANE FILTRATION WITH INDUCED VORTEX

(71) Applicant: SWIRLTEX HOLDINGS CORP., Calgary (CA)

(72) Inventor: Peter James CHRISTOU, Calgary (CA)

(21) Appl. No.: 17/167,657

(22) Filed: Feb. 4, 2021

Related U.S. Application Data
(60) Provisional application No. 62/970,433, filed on Feb. 5, 2020.

(30) Foreign Application Priority Data
Feb. 18, 2020 (CA) 3072828

(51) Int. Cl. C02F 1/44; C02F 1/52

(52) U.S. Cl. CPC C02F 1/444; C02F 1/52

(57) ABSTRACT

A tubular membrane is provided with a vortex generator at an upstream end of the tubular membrane. A spacer with multiple vortex generators may be added to module having a plurality of tubular membranes. A cap over the spacer may have separate inlets for a feed water and gas mixture and recirculating retentate. A system for membrane filtration includes a tubular membrane, a vortex generator, a liquid pump, a gas pump, and a retentate recirculation loop. In a filtration process, a gas is pumped into a flow of a feed liquid to produce a two-phase flow wherein the liquid is the continuous phase. The two-phase flow passes through the vortex generator and through a lumen of the tubular membrane. A continuous gas phase forms in part of the lumen of the tubular membrane. Contaminants in the liquid may be biased towards the continuous gas phase.

### RELATED APPLICATIONS

This application claims the benefit of U.S. Provisional Patent Application No. 62/970,433, Device and Process for Crossflow Membrane Filtration with Induced Vortex, filed on Feb. 5, 2020, and Canadian Application No. 3,072,828, filed Feb. 18, 2020, both of which are incorporated by reference.

### FIELD

This specification relates to cross flow membrane filtration, to water treatment, and to devices for producing a vortex.

### BACKGROUND

US Patent Application Publication Number US 2018/0065090 A1, Tubular Member with Spiral Flow, describes a permeable membrane tube including a cyclone generator configured to cause fluid entering the permeable tube to flow in a spiral direction. The cyclonic generator may be a plug positioned at the fluid entrance of the membrane tube. The fluid is separated into first and second portions. The first portion has a greater density than the second portion and is directed to an inner surface of the tube.

### INTRODUCTION

The following introduction is not intended to limit or define any claimed invention.

This specification describes a vortex generator combined with one or more tubular membranes. In some examples, a tubular membrane module has a plurality of vortex generators mounted in a spacer that may be located adjacent to a potting head of the tubular membrane module. The spacer may be in the range of 50-200 mm thick. The vortex generators may be in the range of 50-300 mm long and fit into bores of the spacer or directly into the tubular membranes of a tubular membrane module without a spacer. The vortex generators may comprise a twisted tape twisted through 3 to 15 full (i.e. 360 degree) rotations. The twisted tape may have a width in the range of 20-100% or 25-75% of the outside diameter of the vortex generator. The tubular membrane may have a cap attached to the spacer. The cap may have an inlet for a mixture of feed water and air. The cap may have a separate inlet for recirculating retentate.

This specification also describes a system and process for membrane filtration. The system includes a tubular membrane and a vortex generator, a liquid pump, and a gas compressor connected to the upstream side of the tubular membrane. The system may also have a retentate recirculation loop. The tubular membrane may be oriented vertically with the upstream end of the tubular membrane module either up or down. Multiple tubular membranes may be connected in parallel. In the process, a gas such as air is pumped into a flow of a liquid such as water to produce a two-phase flow. The two-phase flow passes through the vortex generator and through a lumen of the tubular membrane. The two-phase flow may travel upwards or downwards in the tubular membrane. Air and water may be added to the membranes in a volume ratio between 3:1 and 1:3. A ratio of feed water flow rate to recirculating retentate flow rate may be in a range of 1:10 to 1:50. Axial velocity of liquid in the membranes may be in a range of 0.5-4 m/s or 2-4 m/s. Tangential velocity of water in the membranes may be in the range of 1-16 m/s. The pressure inside the membranes may be in the range of 25-45 psi.

In some examples, the amount of gas added and/or the rotation of the liquid travelling along the length of the tubular membrane induced by the vortex generator and/or a pressure drop downstream of the vortex generator is sufficient to produce a continuous gas phase (which may contain discontinuous liquid, for example droplets) along at least part of the central longitudinal axis of the tubular membrane. For example, the continuous gas phase may occur in 50% or more of the length of the tubular membrane. In some examples, feed water may contain droplets of oil, which are lighter than water. In some examples, the gas added to the liquid may bind with solid particles or non-soluble liquid contaminants in the liquid so as to make buoyant gas-contaminant complexes. Without intending to be limited by theory, the gas-contaminant complexes may be biased towards the continuous gas phase, for example by one or more of flotation relative to centrifugal forces in a vortex, expansion and/or coalescence of bubbles with pressure drop and/or turbulence downstream of the vortex generator, or retention in a frothy interface between the continuous gas phase and an annulus of liquid flowing along the walls of the tubular membrane. In some examples, membrane fouling may be reduced by way of the contaminants being biased away from the wall of the tubular membrane. In some examples, energy efficiency may be increased by the addition of the gas.

### BRIEF DESCRIPTION OF THE FIGURES

FIG. 1 is a cross section of a tubular membrane module.

FIGS. 2A, 2B and 2C show a front, top, and rotated side view of a vortex generator of the tubular membrane module of FIG. 1.

FIG. 3 is an isometric view of another vortex generator of the tubular membrane module of FIG. 1.

FIG. 4 is a side view of the vortex generator of FIG. 3.

FIG. 5A is a top view of an alternative spacer of the module of FIG. 1 with integral vortex generators.

FIG. 5B is a side view of the spacer of FIG. 5A.

FIG. 5C is an isometric view of the space of FIG. 5A.

FIG. 5D is a cross section of the spacer of FIG. 5A along cut line 5D-5D.

FIG. 5E is a cross section of the spacer of FIG. 5A along cut line 5E-5E.

FIG. 6 is a schematic cross section of an assembly of two modules in series having a spacer as in FIG. 5.

FIG. 7 is a schematic process and instrumentation diagram for a filtration system having the tubular membrane module of FIG. 1.

FIG. 8 is another schematic process and instrumentation diagram for a filtration system having tubular membrane modules as in FIG. 1.

FIG. 9A is an isometric view of another spacer for a tubular membrane module as in FIG. 1. FIG. 9B is a cross-section along cut line B-B of the spacer of FIG. 9A.

FIG. 10A is a top view of a vortex generator adapted for use with the spacer of FIG. 9. FIG. 10B is a partially sectioned side view of the vortex generator of FIG. 10A. FIG. 100 is an isometric view of the vortex generator of FIG. 10A.

FIG. 11A is a top view of another vortex generator for use with the spacer of

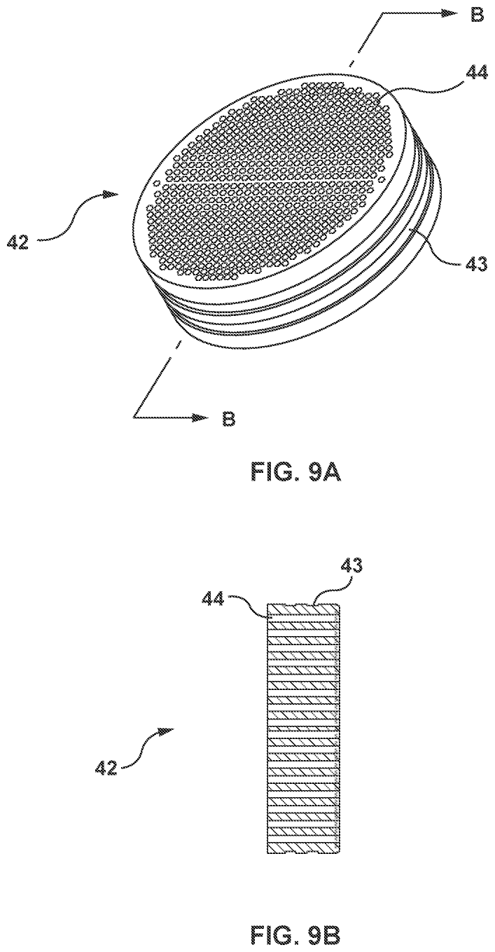

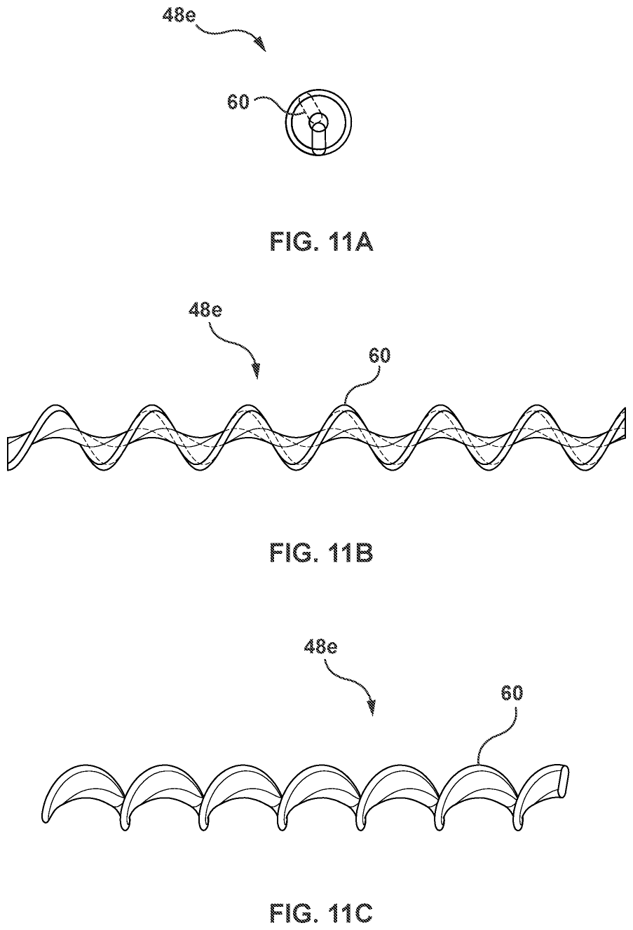

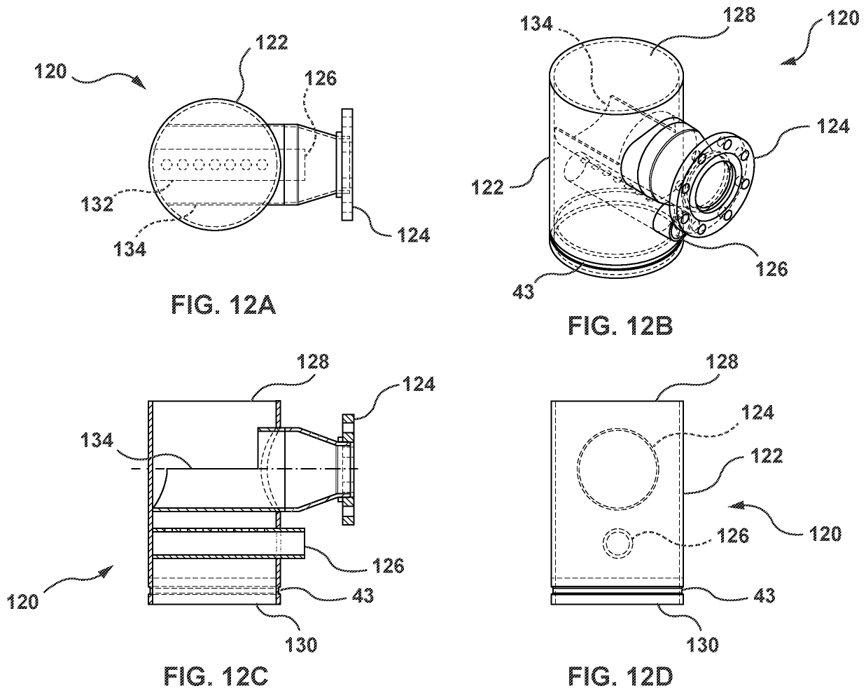

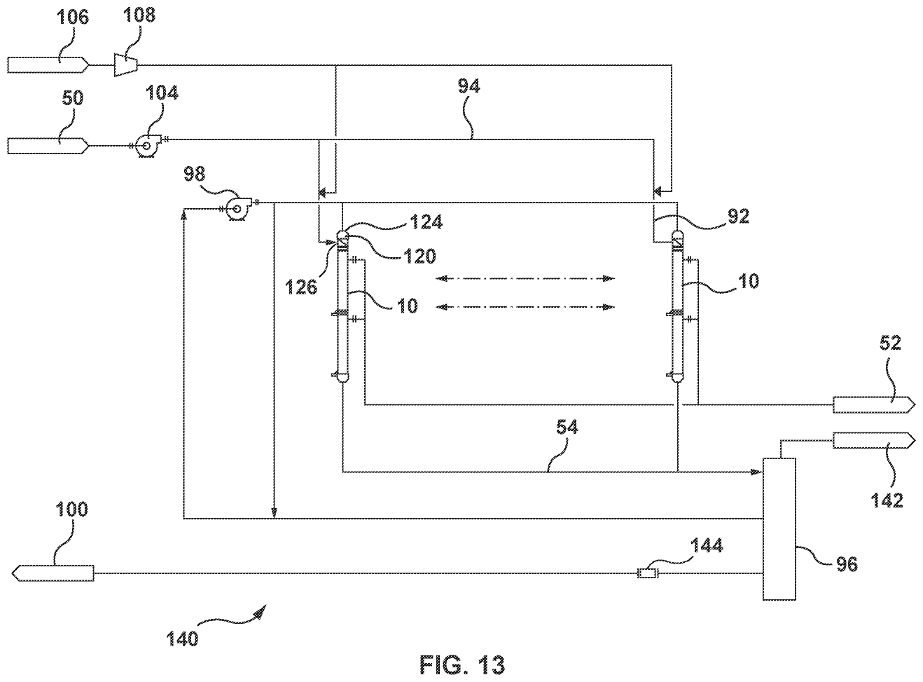

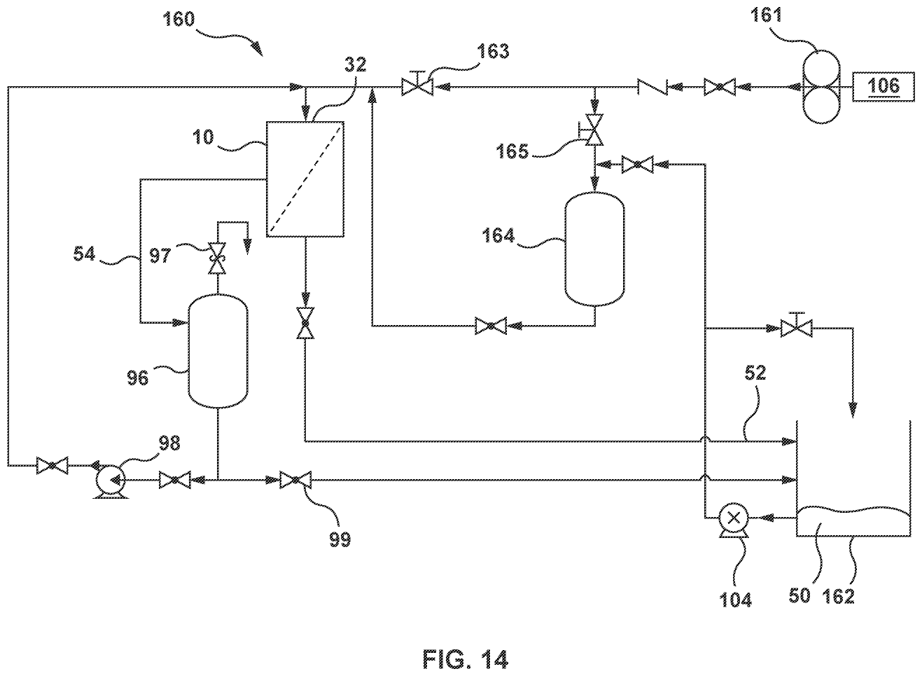

FIG. 9. FIG. 11B is a side view of the vortex generator of FIG. 11A. FIG. 11C is an isometric view of the vortex generator of FIG. 11A.

FIG. 12A is a top view of a cap for use with the spacer of FIG. 9. FIG. 12B is an isometric view of the cap of FIG. 12A. FIG. 12C is a cross-sectioned side view of the cap of FIG. 12A. FIG. 12D is a back view of the cap of FIG. 12A.

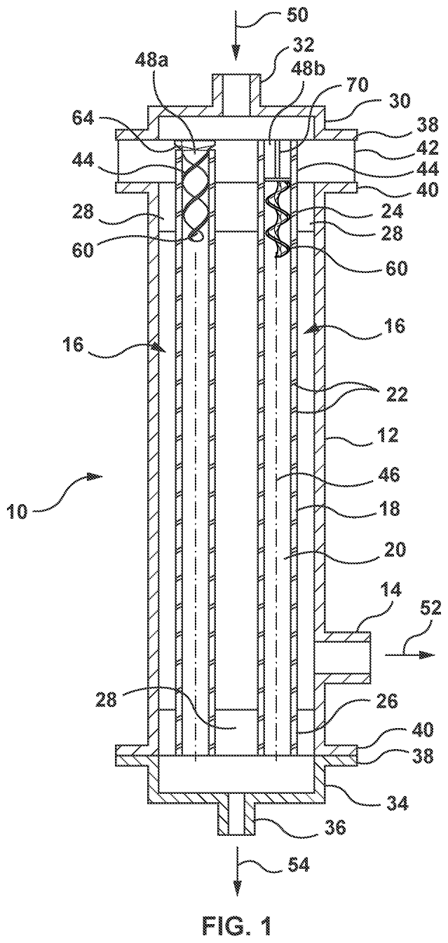

FIG. 13 is another schematic process and instrumentation diagram for a filtration system having tubular membrane modules as in FIG. 1 in parallel branches, showing the first and last branch and omitting one or more intermediate branches to simplify the figure.

FIG. 14 is a schematic process and instrumentation diagram for a filtration system having tubular membrane modules as in FIG. 1 used in an experimental example.

### DETAILED DESCRIPTION

FIG. 1 shows a tubular membrane module 10. The module has a housing 12, alternatively called a shell. The housing 12 has a permeate outlet 14. In some examples, the permeate outlet 14 is located at the top of the module 10 regardless of the orientation of the module. FIG. 1 is not to scale and the housing 12 could have a different, for example greater, ratio of length to diameter. In some examples, the housing 12 has a diameter in the range of 10 cm to 50 cm. The length of the housing may be, for example, 0.5 m to 4.0 m.

The housing 12 contains a number of tubular membranes 16. Two tubular membranes 16 are shown, but a typical membrane module 10 is likely to have many tubular membranes 16, each with a diameter that is smaller than the diameter of the housing 12. For example, the tubular membranes 16 may have inside diameters in the range of 5 mm to 50 mm.

Each tubular membrane 16 has a membrane wall 18 that separates the lumen 20 of the tubular membrane from a plenum defined between the outsides of the tubular membranes 16 and the inside of the housing 12. The membrane wall 18 has pores 22. The pores 22 are highly magnified in FIG. 1 and are typically not visible to the eye. The pores 22 may be, for example, in the range of reverse osmosis, nanofiltration, ultrafiltration or microfiltration.

The structure of the membrane wall 18 is simplified in FIG. 1. The membrane wall 18 typically includes multiple concentric layers including one or more supporting layers and one or more separating layers. A supporting layer may be made, for example, of a porous ceramic tube or a fabric tape wrapped into a tube. A separating layer may be made, for example, of a slurry or polymer solution cast as a liquid on the inside surface of the supporting layer (or layers) and quenched, treated, cured or otherwise converted into a solid with pores 22.

Each tubular membrane 16 has a first end 24 and a second end 26. Both ends 24, 26 are open. In the example shown, first end 24 provides an inlet to the lumen 20 and second end 26 provides an outlet from the lumen 20. Outer surfaces of the ends 24, 26 are sealed to the housing 12 by a potting head 28. The potting head 28 may be, for example, a polyurethane or epoxy resin cured in place between outer surfaces of the ends 24, 26 of the tubular membranes 16 and the inside of the housing 12.

The module 10 has an upper cap 30 with a feed inlet 32. The module 10 also has a lower cap 34 with a retentate outlet 36. The caps 30, 34 are sealed to the ends of the housing 12. For example, flanges 38 of the caps 30, 34 may be attached to flanges 40 of the housing 12 by bolts, couplings, or other fasteners. Gaskets (not shown) are optionally placed between the flanges 38, 40. Alternatively, the flanges 38, 40 may be omitted and couplers such as split couplers may be used to connect the caps 30, 34 to the housing 12. The words “upper”, “lower”, “top”, “bottom” and any similar words are used to simplify reference to the module 10 as shown in FIG. 1. However, the module 10 may be used in other orientations. In particular, the module 10 may be inverted relative to the orientation shown.

In use, fluid to be treated such as feed water 50 flows into the feed inlet 32 and is dispersed in the upper cap 30. The feed water 50 flows into the upper ends 24 of the tubular membranes 16 and downwards through the lumen 20. The feed water 50 is separated by the tubular membranes 16 into a permeate 52, optionally called filtrate, and a retentate 54, optionally called concentrate or brine. The permeate 52 has a reduced concentration of solids and/or non-miscible fluids relative to the feed water 50. The concentrate 54 has an increased concentration of solids and/or non-miscible fluids relative to the feed water 50. The permeate 52 passes through the pores 22 of the membrane wall 18, collects in the housing 12 outside of the tubular membranes 16, and is withdrawn from the permeate outlet 14. The retentate 54 flows out of the second ends 26 of the tubular membranes 16, collects in the lower cap 34 and is withdrawn from the retentate outlet 36. Alternatively, if the module 10 is in a different position, feed water 50 may flow through the module 10 in a different direction. For example, the feed inlet 32 may be at the bottom of the module 10 and feed water 50 may flow upwards through the membranes 16. A generally vertical flow of feed water 50 (either upwards or downwards) may help keep a vortex (as discussed further below) centered within the membrane 16.

The volume of the module 10 within the caps 30, 34 and the lumens 20 may be called the feed side of the module 10. The volume of the module 10 between the inner surfaces of the potting heads 28 and between the outer surfaces of the tubular membranes 16 and the inner surface of the housing 12 may be called the shell side of the module 10. In some cases, though not typically, gas may be released from the permeate 52 within the shell side of the module. The permeate outlet 14 may be located at the top of the module 14, at or near the lower surface of an upper potting head 28, to allow gas to be removed from the housing 12, although in most cases the permeate outlet 14 may be located anywhere on the housing 12.

At the upper end of the module 10, an optional spacer 42 may be inserted between the upper cap 30 and the housing 12. Alternatively, a spacer 42 may be fitted within the upper cap 30 and rest on the upper potting head 28. Optionally, the spacer 42 may be sealed, for example with a gasket or cured liquid sealant, to the potting head 28. The spacer 42 has bores 44 passing through the thickness of the spacer 42. The bores 44 are aligned with the central longitudinal axes 46 of a tubular membrane 16. The bores 44 also contain vortex generators 48. Alternatively, the spacer 42 may be omitted and the vortex generators 48 may be inserted directly into the tubular membranes 16. In this case, an upper portion of the potting heads 28 and/or upper portions of the tubular membranes 16 may be formed to help accommodate the vortex generators 48. However, in a typical module 10, the tubular membranes 16 are placed very close to each other such that there is not much material of the potting heads 28 between them. Further, producing a good seal between the tubular membranes 16 and a potting head 28 with adequate mechanical strength is already challenging in conventional modules. Accordingly, fitting the vortex generators 48 into the spacer 42 may be easier and produce less chance of leakage.

Further, the portion of the tubular membranes 16 between the inner surfaces of the potting heads 28 (i.e. between the lower surface of the upper potting head 28 and the upper surface of the lower potting head 28) is active in filtration whereas portions of the tubular membranes 16 within the potting heads 28 are inactive in that no permeate can flow through them. The separating layer of the tubular membranes 16 is, in some cases, also fragile. Accordingly, adding the spacer 42 can reduce the chance of leakage or reduced permeate quality by reducing or eliminating the extension of the vortex generators 48 into the active area of the tubular membranes 16 where abrasion or other contact between a vortex generator 48 and the separating layer could damage the separating layer. Adding the spacer 42 also helps with creating a vortex including a continuous gas phase (to be discussed further below) higher in the module 10, thereby making better use of the active area of the tubular membranes 16.

In some examples, a vortex generator 48 is in the form of one or more twisted strips, alternatively called tapes. The strips may extend across essentially the entire width (i.e. diameter), for example 80-100%, of the vortex generator 48. Alternatively, the strips may extend across only part of the diameter of the vortex generator 48, for example 25-75% of the diameter of the vortex generator 48, along some or all of the length of the vortex generator 48. In some examples, a strip or strips may leave a portion of the vortex generator 48 along its central longitudinal axis open. The active area of a vortex generator 48 (i.e. a portion of the vortex generator 48 having a surface oblique to its central longitudinal axis) may have a constant diameter or a changing diameter, for example a continuous taper, another type of continuously varying diameter, or a stepped diameter. The outer edges of the vortex generator 48 may be smooth or provided with features of shape such as scallops or a wave. The rate of angular change may be constant or variable. However, the twist (i.e. angular change) is preferably always in one direction, i.e. clockwise or counter-clockwise. The vortex generator 48 is preferably shorter than the tubular membranes 16. For example the length of the vortex generator 48, or the active area of the vortex generator 48, may be less than 25%, or less than 10%, of the length of a tubular membrane 16. Optionally, the length of the vortex generator 48, or the active area of the vortex generator 48, may be in the range of 50-300 mm. In some examples, the vortex generator 48 does not extend over more than 20 cm of the active area of the membrane 16, over more than 10 cm of the active area of the membrane 16, or over any of the active area of the membrane 16.

The vortex generator 48 may be made, for example, of plastic. In some examples, the active portion of the vortex generator is made by heating a strip of plastic, for example above its heat deflection temperature, twisting the strip while it is hot, and then cooling the strip, for example to below its heat deflection temperature, while maintaining the twisted shape. Optionally, the strip may be annealed or otherwise heat-treated to maintain its twisted shape. In other examples, the active portion of the vortex generator is formed directly, for example by injection molding or an additive process such as 3D printing, into a twisted or other shape.

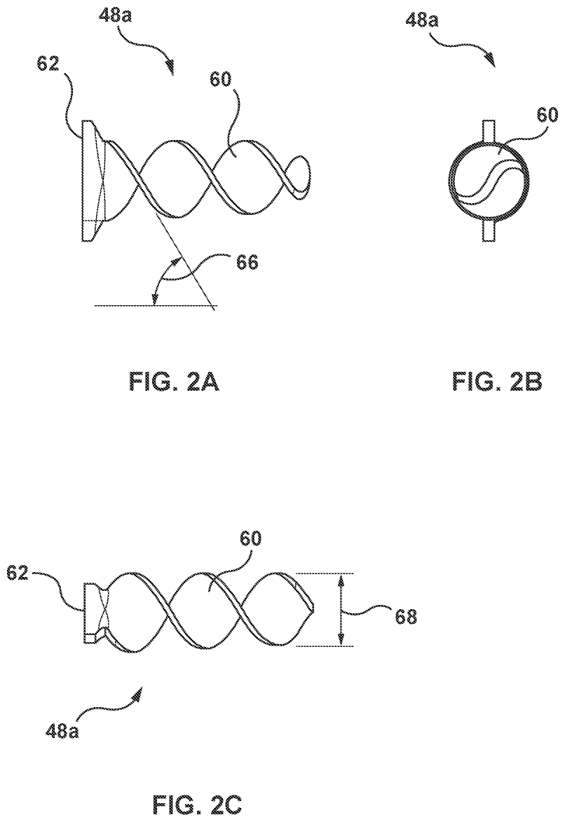

FIGS. 2A, 2B and 2C show an example of a first vortex generator 48a having an active area in the form of a twisted tape 60. The twisted tape 60 extends from a mounting bar 62. Referring back to FIG. 1, the mounting bar 62 can be inserted into a notch 64 in the spacer 42 or, alternatively, in the upper surfaces of the potting head 28 and tubular membranes 16 if no spacer 42 is used. Optionally, the mounting bar 62 can bear against a spacer 42 or a potting head 42 without a notch. A pitch angle 66 may be in the range of 20 to 75 degrees or in the range of 30 to 60 degrees. In this example, the twisted tape 60 extends across substantially the entire diameter 68 of the vortex generator. In the example shown, which is intended for a tubular membrane with an 8 mm inside diameter, the diameter 68 of the tape 60 tapers from 8 mm near the mounting bar 62 to 7 mm near the tip of the first vortex generator 48a. The number of twists (i.e. 360 degree revolutions of the tape 60) may be in the range of 2 to 10, or in the range of 3 to 6.

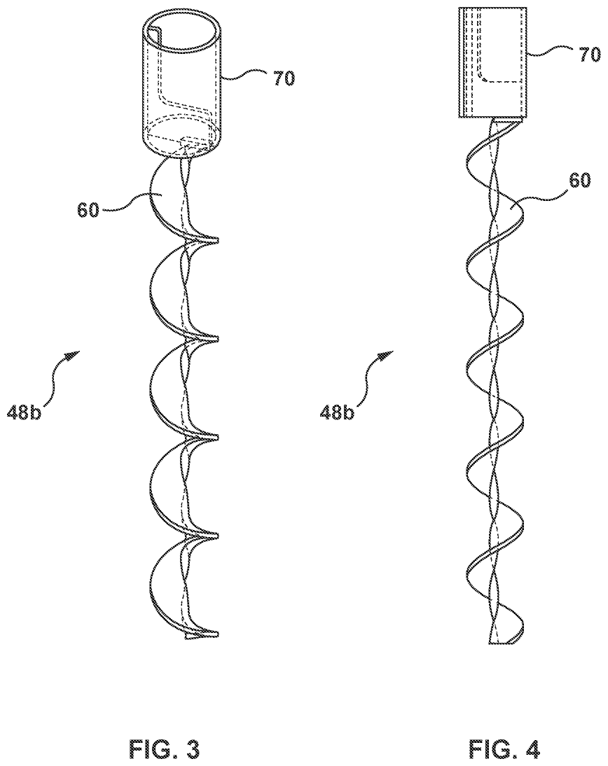

FIGS. 3 and 4 show an example of a second vortex generator 48b. The second vortex generator 48b also has an active area in the form of a twisted tape 60, but in this case the width of the twisted tape 60 is less than the diameter of the active area second vortex generator 48b. In the example shown, the width of the twisted tape 60 is about half of the diameter of the active area of the vortex generator and the diameter of the active area of the second vortex generator 48b is constant. The twisted tape 60 extends from a split collar 70. Referring back to FIG. 1, the split collar 70 is press fit into a bore 44 of the spacer 42. The inside diameter of the split collar 70, when pressed into the bore 44, is substantially the same as the inside diameter of the tubular membranes 16. Alternatively, if a spacer 42 is not used, an upper portion of the tubular membranes 16 and optionally the potting head 28 can be bored out to accept the split collar 70. In another option, the split collar 70 may be fit inside the upper ends 24 of the tubular membranes 16 without modifying them. In this case, the inside diameter of the split collar 70 will be less than the inside diameter of the tubular membranes 16. The pitch angle and number of twists for the second vortex generator 48b may be as described for the first vortex generator 48a.

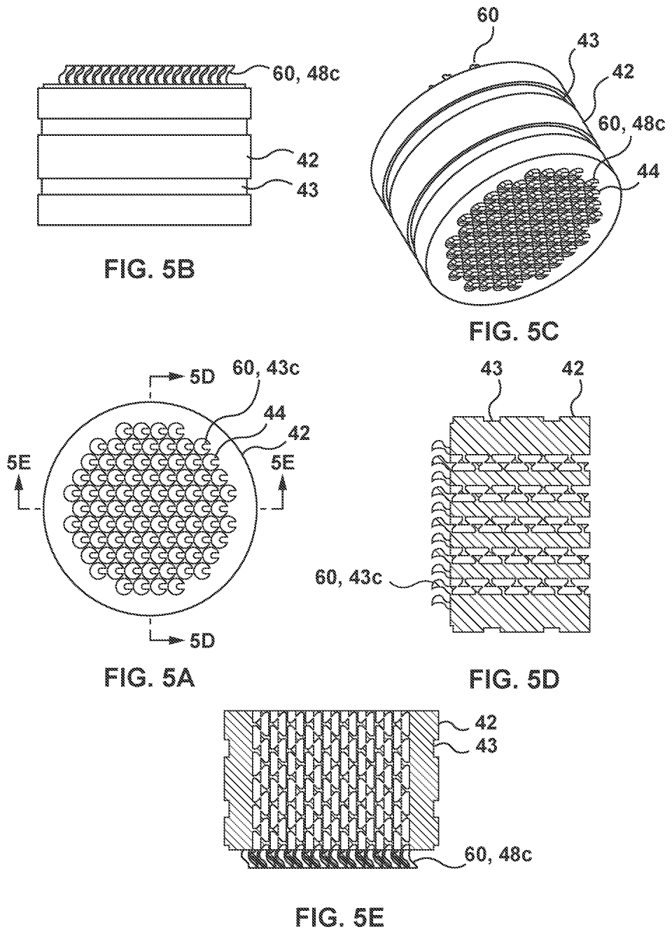

FIGS. 5A to 5E show various views of a spacer 42 for a module 10 having many tubular membranes 16. The bores 44 of the spacer 42 contain third vortex generators 48c. In this example, the third vortex generators 48c are formed integrally with the spacer 42. Alternatively, the spacer 42 could have smooth bores 44 with a stepped diameter and the split collars 70 of the third vortex generators 48b could be inserted into an upper portion of the bores 44 with a larger diameter extending through some of the thickness of the spacer 42. In another option, the upper surface of the spacer 42 may have notches 64 to receive vortex generators 48a as in FIGS. 2A, 2B and 2C. The twisted tapes 60 of the vortex generators 48 extend downwards from a lower surface of the spacer 42. When the spacer 42 is placed over a potting head 28, the twisted tapes 60 extend into the ends 24 of the tubular membranes 16. In some examples the twisted tapes 60 do not extend beyond an inner face of the potting head 28. In other examples the twisted tapes 60 do extend beyond the inner face of the potting head 28. A module 10 for use with the spacer 42 shown has a tubular membrane 16 in line with each of the vortex generators 48b. Optionally, the spacer 42 can be removed from the module 10 if required for maintenance or cleaning. Optionally, the spacer has grooves 43 to receive grooved split couplers, such as a Victaulic™ couplers, between the spacer 42 and the housing 12 (which may also have a groove) and between the spacer 42 and the upper cap 30 (which may also have a groove). Alternatively, the spacer 42 may be clamped between flanges 38, 40 as shown in FIG. 1.

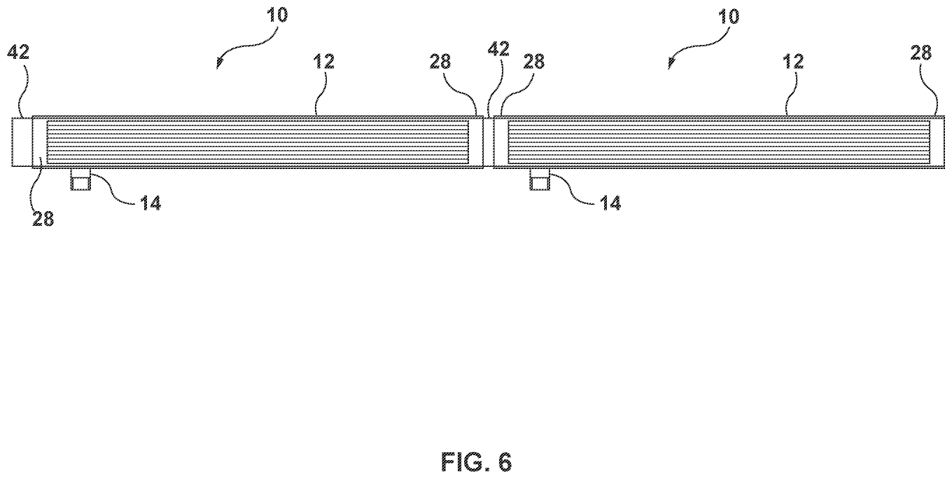

FIG. 6 shows an assembly of two modules 10 in series. Caps 30, 34 and a coupler between the two modules 10 are not shown to simplify the drawings. A spacer 42 as in FIG. 5 is placed over an upper potting head 28 of the upstream module 10. Another spacer 42 is placed between the two modules 10. This spacer 42 is generally as shown in FIG. 5 but with vortex generators 48 extending in both directions from the upper and lower surfaces of the spacer 42. The active areas 60 of the vortex generators 48 extending into the upstream end of the downstream module 10 and into the downstream end of the upstream module 10. Alternatively, a spacer as shown in FIG. 5 may be used with active areas 60 of the vortex generators 48 extending only beyond the lower surface of the spacer 42 into the upstream end of the downstream module 10. In either case, vortex generators 48 between two modules create vortices in the tubular membranes 16 of the downstream module 10.

A vortex generator 48 may extend from a spacer 42, through a portion of an upstream end 24 of a tubular membrane 16, or beyond the upstream end 24. In some cases, a separation layer on the inside surface of the membrane wall 18 is sensitive to abrasion or other physical contact. To reduce or avoid leaks caused by abrasion, the vortex generator 42 may be restricted to the spacer 42, if any, and/or the end 24, which is a non-permeating portion of the tubular membrane 16. Alternatively or additionally, a downstream end of the vortex generator 48 may be tapered or have a reduced diameter so that is does not contact the inside surface of the membrane wall 18.

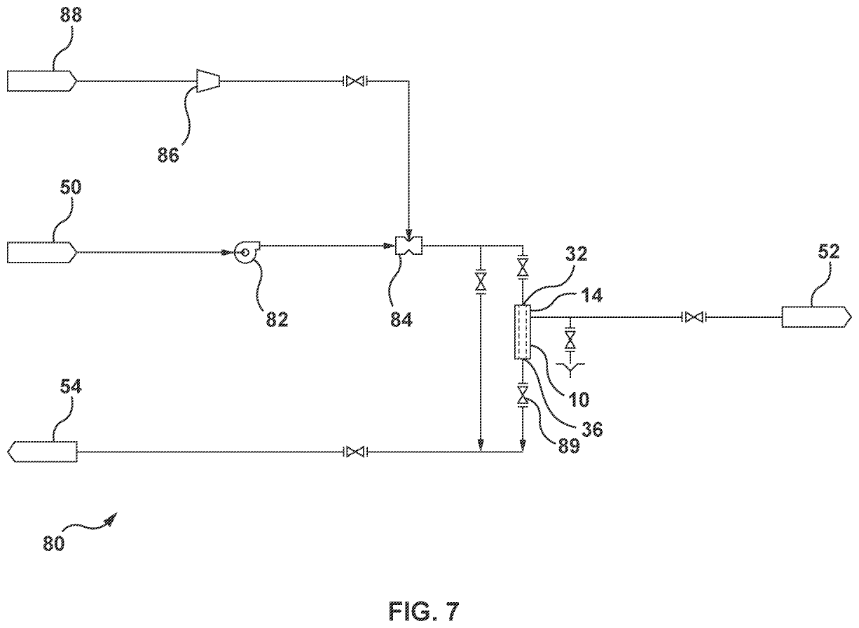

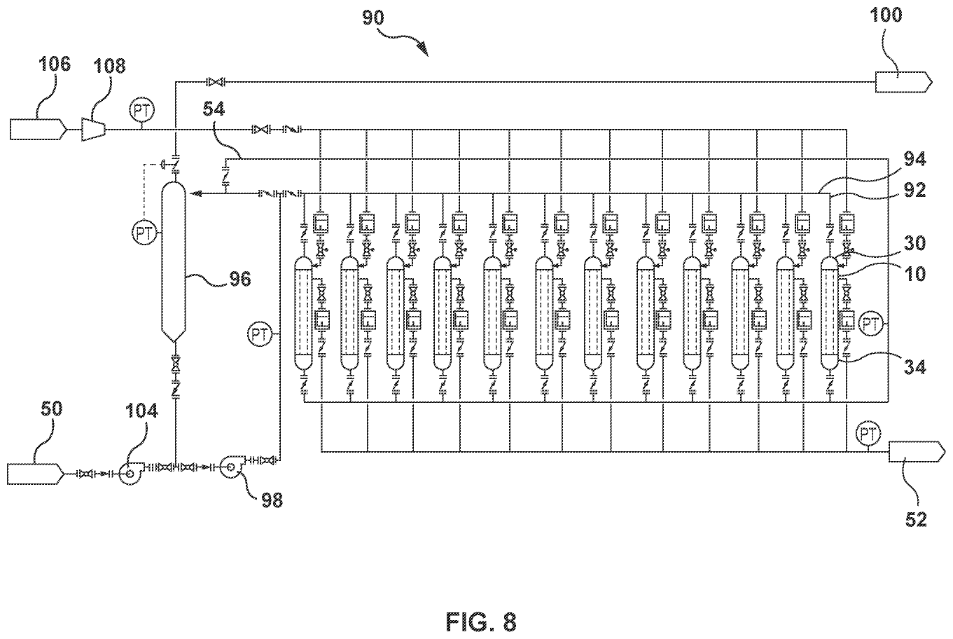

FIG. 7 shows a system 80 for membrane filtration. The system 80 includes a tubular membrane module 10 as in FIG. 1. Feed water 50 is drawn, for example from a tank or supply pipe, by a pump 82. The pump 82 pushes the feed water through a mixer 84 to the feed inlet 32 of the module 10. A compressor 86 delivers a compressed gas 88, typically air to the mixer 84. The compressed gas 88 is injected into the feed water 50. The gas 88 is provided as bubbles within feed water 50.

The feed water 50 flows through the module 10 as described above and is separated into permeate 52 and concentrate 54. A back pressure valve 89 downstream of the concentrate outlet 36 maintains a selected pressure in the feed side of the module 10.

The pressure of the feed side of the module 10 is kept higher than the pressure of the shell side of the module 10 by a selected transmembrane pressure (TMP). In the example shown, the feed water 50 flows downwards through the module 10. Compared to an upwards flow of feed water 50, this may help to increase the residence time of air within the module 10. However, the system 80 and other systems described herein may be modified such that feed water 50 flows upwards through the modules 10, in which case the vortex generators 48 and a optionally a spacer 42 would be located at the bottom of a module 10.

FIG. 8 shows a second system 90. Feed water 50 is pumped through a feed pump 104 and a recirculation pump 98 to a set of modules 10. Some recirculating retentate 54 is added to, and becomes part of, feed water 50. A gas, such as air 106, is added to the feed water 50 by a compressor 108 creating bubbles in the feed water 50. At least some of bubbles attach to contaminants in the feed water 50, altering their buoyancy. FIG. 8 is schematic and shows the air being injected into upper caps 30 of the modules 10. Optionally, this can be achieved by using the second caps 120 of FIGS. 12A-D in place of upper caps 30 and injecting the air into the second inlets 126. Optionally, air may be injected, for example through a nozzle or T-junction, into feed pipes 92 carrying feed water 50 from a feed water header 94 to the modules 10 rather than directly into upper caps 30 or second caps 120. The feed water 50 and air flows through the tubular membrane in the modules 10 wherein vortex generators create a spinning flow pattern and centrifugal force within the tubular membranes. The centrifugal force helps to separate the gas-attached contaminants from the feed water 50 based on their buoyancy. The feed water 50 is forced against the separation layers of the tubular membranes while buoyancy manipulated contaminants are drawn to the central longitudinal axes of the tubular membranes. Part of the feed liquid is forced through the membrane walls creating permeate 52 while contaminants flow through the downstream end of the tubular membranes as retentate 54. The permeate 52 is the finished product, although it is optionally treated further. The retentate 54 flows to an air relief column 96. The air previously injected into the feed water 50 is released from the retentate 54 in an air relief column 96. A portion of the de-gassed retentate 54 is removed from the system 90 through a drain 100, which may be connected to a further processing unit. Another portion of the de-gassed retentate 54 is recycled through recirculation pump 98 to the modules 10. Optionally, the recirculated retentate may be fed to a first inlet 124 of a second cap 120 of the modules 10. The portion of the retentate 54 removed from the system 90 may be selected such that the contaminants are not overly concentrated. For example, the flow rate of retentate 54 to the drain 100 may be 0.02 to 4 times, or 0.1 to 4 times, or 1 to 4 times the flow rate of permeate 52. The air 106 is supplied to the feed pipes 92 at a pressure above the pressure in the feed pipes 92 upstream of the air injection point. In an example, the air is added through a T-junction or a small, for example 0.5 mm, orifice. Optionally, for example when using a small orifice, the air enters the water at a high velocity. Without intending to be limited by theory, the air may enter the water with sufficient velocity to create eddy diffusion. Eddy diffusion may occur because in turbulent flow small volumes of gas have a continuous random motion, which is superimposed on the time average velocity of the stream and acts to increase bubble attachment to contaminants in addition to spreading the diffusing material throughout the stream. However, creating eddy diffusion is not necessary to produce bubbles that attach to contaminants in the feed water. In at least some examples, mixing the feed water 50 with air 106 introduces bubbles that bind to contaminant particles in the feed water 50, making them buoyant. The contaminants may be solids or non-soluble liquid particles or both. The feed water 50 may be chemically treated to promote contaminant aggregation and/or bubble attachment to the contaminants. Optionally, the air may be injected through a nozzle with one or more outlets, for example a flat fan nozzle with multiple 0.5 mm orifices. When the buoyant contaminant/bubble complexes flow though a vortex in a tubular membrane 16, they are biased by their buoyancy towards the central longitudinal axis 46 of the tubular membrane 16, away from the membrane walls 18, and/or accumulate at an interface between the feed water 50 and a region of continuous gas phase along the central longitudinal axis 46 of the tubular membrane 16. Feed water 50 flowing in a vortex in the membranes forms an annular layer with a continuous liquid phase (typically still including some bubbles) around the continuous gas phase. In some cases, the continuous gas phase is foamy or frothy or has a foamy or frothy interface with annular layer of feed water 50 in the membranes. The addition of a gas into the feed water 50 also reduces the volume of feed water 50 required to fill the tubular membrane 16 which may reduce the energy required to pump the feed water 50 at a particular linear velocity through the membranes.

A bubbles size of 10-1000 microns, optionally 75-655 microns, may be provided in the feed water 50 entering a tubular membrane 16. Optionally a very small bubbles, for example between 10-45 microns, may be produced at an upstream gas injection point because the smaller bubbles have a higher probability to displace the surface tension around the contaminants, therefore creating a higher potential for bubble attachment. Further, the smaller bubbles at the injection site may coalesce after injection to produce larger bubbles at the first end 24 of the tubular membranes 16. Some of the bubbles may also coalesce to produce a region having a continuous gas phase along at least a portion of the central longitudinal axis 46 of the tubular membrane 16, in some cases aided by a pressure drop downstream of the vortex generator 48. The continuous gas phase portion may occupy 50% or more of the length of the tubular membrane 16. The amount of air added to the feed water 50 may be selected to be sufficient to produce the continuous gas phase region.

The air (or other gas) that is added to the feed water tends to concentrate along the central longitudinal axis of the tubular membranes due to the centrifugal force created by the spiral flow pattern and/or the injected air pressure and/or the flow rate of air relative to water. A continuous gas phase (which may be or include a froth or foam), surrounded by an annular continuous liquid phase, may be created along at least part of the central longitudinal axis of the tubular membrane. In the downward flow configuration (wherein feed water flows downwards through a vertically oriented tubular membrane), a continuous gas phase is created along at least part of the central longitudinal axis of the tubular membrane, in some examples, with 0.01-0.5 m³/hr of air (or other gas) added to each tubular membrane. In some examples, 0.05 to 3.5 liters per minute of air, at 15C and 30-90 psi, is added to an 8 mm diameter membrane 16. However, if the volume of the continuous gas phase is too large, for example more than 83% of the liquid volume, a stabilized annular flow of water around a continuous gas phase may not be achieved.

Air injection may be more effective in moving contaminants into a continuous gas phase along the central longitudinal axis of the tubular membrane if there is a floc structure to the contaminants in the feed water. The increased surface area of floc can improve bubble attachment. A chemical flocculation aid (for example a polymeric or metal salt flocculant) can be added to improve the removal of some contaminants.

The liquid pressure in a recirculation loop through the tubular membranes can be controlled by controlling the volume of water being pumped into the recirculation loop and the volume of water removed from the recirculation loop. The feed pump adds enough volume of water to the recirculation loop to balance the permeate and concentrate removed from the recirculation loop. The liquid pressure in the system (measured for example directly upstream of the membrane modules) can be, for example between 200 and 650 kPa. In some examples, the feed pump operates at a continuous speed and the liquid pressure in the recirculation loop is controlled, at least in part, by modulating a valve that controls the flow rate of retentate being removed from the recirculation loop. If the pressure needs to be lowered or increased an operator or an automatic controller adjusts the wasting valve to increase or decrease the flow of retentate leaving the recirculation loop. The liquid pressure in the system is also affected by the air added to the system. Increasing the rate of air flow into the system increases the pressure and/or velocity of flow through the tubular membranes. Although the rate of air flow can be controlled dynamically, the rate of air flow is typically selected during a design or piloting phase and remains generally constant in operation.

The air added to the feed water is concentrated along the central longitudinal axis of the tubular membranes and is removed from the tubular membranes primarily in the retentate. In a system having retentate recirculation, the free air can be removed from the retentate before it is returned to the recirculation pump. Air is removed from the water after each circulation through the tubular membranes such that additional air can be added into a mixture of recirculating retentate and fresh feed water in a way that encourages bubble attachment to additional contaminants. The degassing of the retentate stream may also protect the recirculation pump and allows for more accurate measurement of the liquid volume or retentate removed from the system and/or returned to the tubular membrane.

In an example, a system 90 is used to treat produced water, for example produced water collected from a fracking or SAGD operation. The produced water may be pre-treated but still contains, among other things, residual hydrocarbons or high molecular weight liquid organics (possibly emulsified), TSS and various salts. In some examples, modules 10 have tubular membranes each with a length of about 1 m and internal diameter of 8 mm. The separation layer of the tubular membranes may have a pore size between 0.002 and 0.1 microns. The separation layer may be made, for example, of polysulfone, polyestersulfone or PVDF. In one example tubular membranes have a separation layer of PVDF with a nominal 0.03 micron (um) pore size.

In an example, the liquid feed pressure (measured for example immediately upstream of the modules) is about 200 kPa. Air is provided at about 550 kPa from an air compressor and injected through a flat fan nozzle with a 0.5 mm orifice into the recirculating water. The tubular membranes have vortex generators using a full-width twisted tape design with a 45 degree pitch angle and 6 twists. The diameter of the vortex generators was 8 mm at their upstream tapering uniformly to 7 mm at their downstream end.

FIGS. 9A and 9B show another spacer 42 for a large tubular membrane module 10. The spacer 42 has many bores 44, for example 20 or more, each aligned with a longitudinal axis of a tubular membrane 16 of a module 10. The inside diameter of the bores 44 may be similar to, i.e. within 25% of, the inside diameter of the tubular membranes 16 of a module 10. In the example shown, the spacer 42 is intended for use with a module 10 having tubular membranes 16 with an 8 mm internal diameter and the bores 44 have an internal diameter of 8 mm. Optionally, bores 44 of other diameters may be provided for use with membranes 16 of other diameters. Optionally, the spacer 42 has grooves 43 for use with a split ring coupler. In the example shown, the spacer 42 has sufficient thickness, for example 50 mm or more or 75 mm or more, such that a vortex generator 48 may be contained completely within a bore 44. The length of a vortex generator 48 may be, for example, between 50 mm and 200 mm. The thickness of a spacer 42 may be in a range of 50 mm to 200 mm.

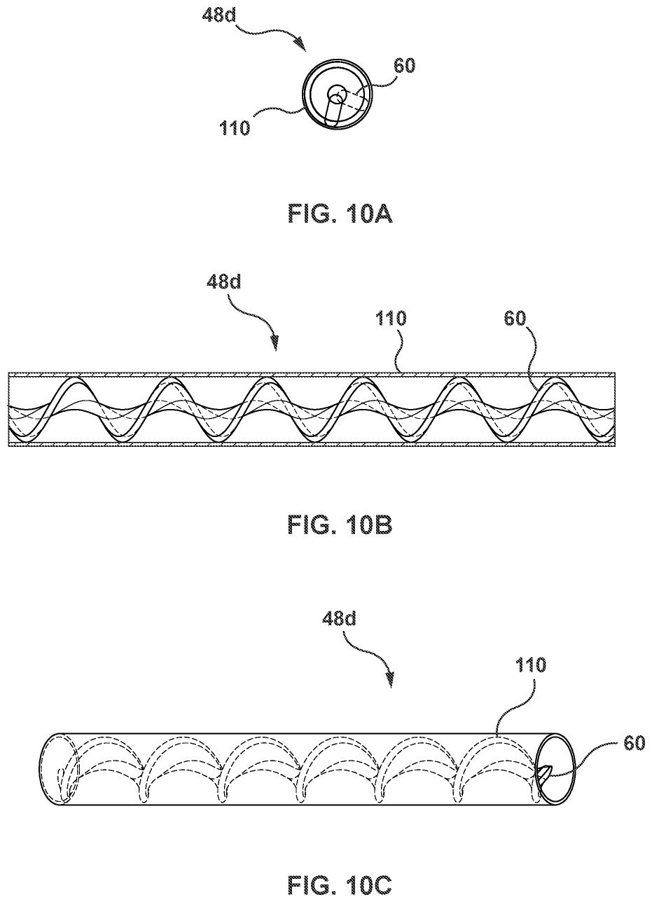

FIGS. 10A, 10B and 100 show a fourth vortex generator 48d. The fourth vortex generator 48d is intended for use with the spacer 42 of FIG. 9 but may also be used with other spacers. The fourth vortex generator 48d has an active area in the form of a twisted tape 60. In the example shown, the width of the twisted tape 60 is less than, for example about half of, the outside diameter of the fourth vortex generator 48d. The diameter of the fourth vortex generator 48d is constant. In the example shown, the fourth vortex generator 48d has a pitch angle of 60 degrees and about 6 twists. Optionally, another pitch angle or number of twists may be used.

FIGS. 11A, 11B and 110 show a fifth vortex generator 48e. The fifth vortex generator 48e is intended for use with the spacer 42 of FIG. 9 but may also be used with other spacers. The fifth vortex generator 48e has an active area in the form of a twisted tape 60. In the example shown, the width of the twisted tape 60 is less than, for example about half of, the outside diameter of the fifth vortex generator 48e. The diameter of the fifth vortex generator 48e is constant. In the example shown, the fifth vortex generator 48e has a pitch angle of 60 degrees and about 6 twists. Optionally, another pitch angle or number of twists may be used.

The fourth vortex generator 48d has an outer tube 110 that defines its outer diameter, as shown in FIGS. 10A-C. In contrast, the fifth vortex generator 48e as shown in FIGS. 11A-C does not have an outer tube 110 and the twisted tape 60 defines its outer diameter. The outside diameter and length of the fourth vortex generator 48d and fifth vortex generator 48e are essentially the same as the length and inside diameter of the bores 44 of the spacer 42. A fourth vortex generator 48d or fifth vortex generator 48e may be fit, for example press fit, into a bore 44 of the spacer 42. The outer tube 110 is optional, but may help secure the fourth vortex generator 48d to the spacer 42. The reduced width of the twisted tape 60 relative to the outside diameter of the fourth vortex generator 48d and fifth vortex generator 48e helps to reduce clogging and plugging relative to a vortex generator with a twisted tape 60 extending across its entire outside diameter. A twisted tape 60 having a width that is in the range of 25-75%, or 40-60%, of the external diameter of a vortex generator may be useful for treating water with a high solids content and/or stringy contaminants such as hair or fibers.

A spacer 42 with open bores 44, in combination with separately made vortex generators 48 mounted in the bores 44, may be more suitable for high volume manufacturing techniques, such as injection molding, relative to a spacer 42 with integral vortex generators 48. A two-part construction, with separately made spacer 42 and vortex generators 48, also permits different materials to be used for the spacer 42 and the vortex generators 48. Optionally, the vortex generators 48 may also be removable. In this case, the two-part construction also allows the vortex generators 48 to be replaced without replacing a spacer 42.

FIGS. 12A, 12B, 12C and 12D show a second cap 120. The second cap 120 may be used in place of the upper cap 30 described above. The second cap 120 may also be used with the spacer 42 of FIG. 9. The second cap 120 has a body 122. An upper part 128 of the body 122 is sealed while a lower part 130 of the body 122 is open. A groove 43 in the lower part 130 of the body 122 may be used to attach the second cap 120 to a spacer 42, for example by way of a split coupling. The second cap 120 also has a first inlet 124 and a second inlet 126. The first inlet 124 is located above the second inlet 126. Fluid entering the first inlet 124 or the second inlet 126 may flow through lower part 130 of the cap, and then through the bores 44 of the spacer 42 and into the membranes 16.

In an example of a system to be described below, water flowing in a retentate concentrate loop and feed water are fed to a second cap 120 of a module 10 separately. In this case, a pipe of the retentate concentration loop is connected to the first inlet 124 and a pipe connected to a feed pump is connected to the second inlet. Optionally, the first inlet 124 has a larger diameter than the second inlet 126. Feed air 106 is mixed with the feed water 50 and also flows into the second inlet 126. The second inlet 126 may be connected to a nozzle 132 within the body 122 of the second cap 120. Optionally the nozzle 132 has multiple ports to disperse a mixture, optionally a two-phase mixture, of water and air into the second cap 120. The ports may be directed upwards. Optionally, a baffle 134 occupies part of the cross-sectional area within the second cap 120 vertically between the first inlet 124 and the second inlet 126. In an example shown in FIGS. 12E and 12F, a baffle 134 is made by cutting away some of the walls of a section of pipe extending into the body from the first inlet 124. The baffle 134 inhibits large bubbles from rising from the nozzle 132 above the first inlet 124. The baffle 134 may also increase the velocity and/or turbulence of water flowing downwards from the first inlet 124 to help entrain or break up large bubbles in the second cap 120. The design of the second cap 120, for example baffle 134, helps to more evenly distribute a mixture of water and air across the spacer 42 and to the membranes 16. Having the feed water 50 and air 106 enter from the side of the second cap 120 and/or below the entry point for recirculating retentate also helps to prevent air from accumulating in the second cap 120.

FIG. 13 shows a third system 140. Feed water 50 is pumped through a feed pump 104 to a set of modules 10. Each module 10 may be an assembly of multiple, for example 2-4 modules 10 in series having a spacer 42 with vortex generators 48 at the upstream end of each module 10 as shown in FIG. 6. A third system 140 may have, for example, 4-20 modules 10 (which may be compound module 10 or 2-4 modules 10 in series) in parallel. The module 10 (which may be a compound module 10 or 2-4 modules 10 in series) in each parallel branch many be, for example, 1-5 m long. Feed pump 106 is connected through a feed water header 94 and feed pipes 92 to the second inlets 126 of the modules 10. Air 106 is added to the feed water 50 by a compressor 108 creating bubbles in the feed water 50. Air 106 may be injected through a nozzle into feed water header 94, or into feed pipes 92 as shown. Injecting air 106 into only the feed water 50, rather than into a combination of feed water 50 and recirculating retentate 54, is expected to improve the attachment of bubbles to solid particles in the feed water 50.

Some recirculating retentate 54 is directed, by recirculation pump 98, into first inlets 124 of the modules 10. The recirculating retentate 54 mixes with feed water 50 and air 106 in the second caps 120. The mixture flows through vortex generators 48 in the spacer 42 and then through the tubular membranes 16 in the modules 10.

The vortex generators 48 create a spinning flow pattern and centrifugal force within the tubular membranes 16. The centrifugal force helps to separate gas-attached contaminants from the feed water 50 and recirculating retentate 54 based on their buoyancy. The feed water 50 and recirculating retentate 54 are forced against the separation layers of the tubular membranes 16 while buoyancy manipulated contaminants are drawn to the central longitudinal axes of the tubular membranes 16. Part of the feed water 50 and recirculating retentate 54 are forced through the membrane walls 18 creating permeate 52 while contaminants flow through the second end 26 of the tubular membranes 16 as retentate 54. The permeate 52 is the finished product, although it is optionally treated further.

The retentate 54 flows from the modules 10 to an air relief column 96. Free air 142 is released from the retentate 54 in the air relief column 96. However, small bubbles, i.e. microbubbles, may remain in the retentate 56. At least some of the bubbles may be complexed with solids from the feed water 50. A portion of the de-gassed retentate 54 is removed from the system 90 through a drain 100, which may be connected to a further processing unit. Optionally, the amount of retentate 54 wasted form the system is controlled by a pressure relief valve 144, which also maintains a generally constant feed side pressure and transmembrane pressure in the third system 140. Another portion of the de-gassed retentate 54 is recirculation through the recirculation pump 98.

The air 106 is supplied to the feed pipes 92 through a T-junction. In at least some examples, mixing the feed water 50 with air 106 introduces bubbles that bind to contaminant particles in the feed water 50, making them buoyant. The contaminants may be solids or non-soluble liquid particles or both. The feed water 50 may be chemically treated to promote contaminant aggregation and/or bubble attachment to the contaminants. When the buoyant contaminant/bubble complexes flow though a vortex generator 48 in a tubular membrane 16, they are biased by their buoyancy towards the central longitudinal axis 46 of the tubular membrane 16, away from the membrane walls 18, and/or accumulate at an interface between the feed water 50 and a region of continuous gas phase along the central longitudinal axis 46 of the tubular membrane 16. Feed water 50 flowing in a vortex in the membranes forms an annular layer with a continuous liquid phase (typically still including some bubbles) around the continuous gas phase. In some cases, the continuous gas phase is foamy or frothy or has a foamy or frothy interface with annular layer of feed water 50 in the membranes. The addition of a gas into the feed water 50 also reduces the volume of feed water 50 required to fill the tubular membrane 16 which may reduce the energy required to pump the feed water 50 at a particular linear (i.e. axial) velocity through the membranes or increase the axial velocity of the water. Air and water may be fed to the membranes in a volumetric flow rate ratio between 3:1 and 1:3, for example as measured at the second cap 120 or otherwise with the volumetric flow rate of air corrected to the temperature and pressure of the water. A ratio of feed water flow rate to recirculating retentate flow rate may be in a range of 1:10 to 1:50. Axial velocity of liquid in the membranes may be in a range of 0.5-4 m/s or 2-4 m/s. Tangential velocity of water in the membranes may be in the range of 1-16 m/s. The pressure inside the membranes may be in the range of 25-45 psi.

A parallel system configuration is preferred because a vortex generator is required every 0.5 to 2.0 m of membrane length to maintain a continuous gas phase inside of a liquid annulus along most of the length of the membranes. The vortex generators also cause a pressure drop (i.e. about 0.5 psi), and the removal of permeate reduces the energy of the flowing feed water. With long modules, or connections of modules in series, that are 4 m or more in length, the continuous gas phase tends to occur only along part of the membrane length. However, because of the continuous gas phase, a parallel system configuration can be used. In contrast, conventional tubular membrane systems do not use short (i.e. less than 4 m) membrane modules in many (i.e. 5 or more or 10 or more) parallel branches because the volume of water that would need to be pumped to maintain a selected cross flow velocity is very high.

In a design example, 12 compound membranes modules 10 are plumbed in parallel in a third system 140 as shown in FIG. 13. Each compound membrane module is a total of 2 m long, and made up of two modules each 1 m long. The total membrane surface area is 312 square meters. The design permeate flux is 90 Lmh. The feed pump 104 is rated at 7 hp and produces 58 m³/h of flow at 45 psi. The recirculation pump 98 is rated at 62 hp and produces 1200 m³/h of flow at 20 psi. Although the recirculation pump 98 operates at 20 psi, the system feed pressure is about 45 psi. The air compressor 108 is rated for 5 hp. The total energy consumption of the system is 1.96 kW/m³.

In a comparative design example, 6 compound membrane modules are connected in series, without vortex generators or air added to the feed water. The membranes in each module are 4 m long. The total membrane surface area is 312 square meters. The design permeate flux is 90 Lmh. A feed pump is rated at 10 hp and produces 170 m³/h of flow at 14 psi. A recirculation pump 98 is rated at 150 hp and produces 440 m³/h of flow at 84 psi. The total energy consumption of the system is 3.5 kW/m³.

FIG. 14 shows a fourth system 160 used in an experimental trial. The fourth system 160 has a tubular membrane module 10 having three tubular membranes 16 in a clear plastic housing 12. The membranes 16 are polymeric membranes with a MWCO of 250 kDa, 8 mm inside diameter, 1 m length and 0.07 m² surface area. The membranes 16 are cleaned between trials and tested with tap water to verify that the membranes 16 have returned to a baseline clean water flux.

In some trials, a first vortex generator 48a, generally as shown in FIGS. 2A, 2B and 2C, is inserted into in each of the tubular membranes 16. The mounting bars 62 of the first vortex generators 48a bear against the top of the potting head 28 of the module 10. The first vortex generators 48a are 3 inches (75 mm) long with a full width helix at a pitch angle 66 of 45 degrees. The module 10 has am upper cap 30 generally as shown in FIG. 1 but attached directly over the potting head 28 without a spacer 42.

Feed water 50 is drawn from a feed tank 162 by a feed pump 104 and flows to a saturation tank 164 at 1 L/min and 85 psi. In some trials, a microbubble gas valve 165 is closed and the feed water 50 merely flows through the saturation tank 164 without any air being added to the feed water 50 in the saturation tank. In other trials, the microbubble gas valve 165 is open, which provides air at 90 psi to a microbubble generator in the saturation tank 164, which saturates the feed water 50 with microbubbles. In this example the microbubble generator is a cavitation device. Air 106 is supplied to the fourth system 160 by an air compressor 161 with an air reservoir tank (not shown). Air 106 is provided in bulk to the module 10 through a bulk air valve 163. The bulk air 106 is added at 45 psi through one leg of a T-junction to the feed water 50 upstream of the module 10. Permeate 52 is recycled to the feed tank 162 in experimental trials to avoid concentrating the feed water during a trial. Retentate 54 collected from the lumens of the membranes 16 at the lower ends of the membranes 16 passes to an air relief vessel 96. Free air is vented from the air relief vessel 96 through an air relief valve 97. Some of the retentate 54 passes through a pressure relief valve 99 and returns to the feed tank 162. The rest of the retentate 54 is recirculated by a recirculation pump 98 to a T-junction where the retentate is mixed with feed water 50 and air 106 before flowing to the feed inlet 32 of the module 10. The pressure relief valve 99 maintains the pressure within the recirculation loop. The permeate side of the module 10 is at atmospheric pressure.

The fourth system 160 was operated under various conditions to investigate the effect of the first vortex generators 48a, bulk air 106 and the microbubble saturation in the saturation tank 164.

In some trials, micro-bubbles are generated in the saturation tank 164. A cavitation device functions as a microbubble generator within the saturation tank 164 and produces bubbles with a diameter 1 mm or less. Air is provided at 0.5 L/min (measured at 15C and 90 psi) to the saturation tank 164. The feed water 50 is believed to be saturated with microbubbles when it leaves the saturation tank 164. The residence time of feed water 50 in the saturation tank 164 (5 minutes), and between the saturation tank 164 and the module 10, is believed to be sufficient for microbubbles to attach to solids in the feed water 50.

Liquid flow through the module 10 is 10 L/min. This flow is made up of 9 L/min. of recirculating retentate 54 and 1 L/min. of feed water 50. The axial flow velocity through the membranes 16, calculated based on the amount of liquid flow only, is 1.0+−0.3 m/s.

In some trials, air 106 is added in bulk to the feed water. Bulk air 106 is injected into the feed water 50 through a T-junction upstream of the module 10. The flow rate of the bulk air is 9 L/min, measured at 15C and 90 psi. In a separate experiment, 3 L/min of bulk air was injected into 3.3 L/min of water and passed through a vortex generator as described above into a clear plastic 8 mm diameter. A vortex was observed in the plastic tube. A gas phase region extended along the central longitudinal axis of the tube. The gas phase region was surrounded by an annulus of water between the gas phase and the inside of the plastic tube. Based on these observations, it is expected that a similar vortex and annulus form inside the membranes 16 in trials where bulk air is added. It is also expected that adding bulk air will increase the cross flow velocity against the membrane surface compared to the nominal velocity of 1.0 m/s described above.

The fourth system 160 was operated in five trials with different configurations as described in Table 1. The membranes 16 were cleaned between trials. The feed water 50 is activated sludge with a total suspended solids (TSS) concentration of 777 ppm. The volume of feed water 50 in each trial is 20-27L. The pressure at the upstream end of the module 10 in each trial was 36 psi. The pressure at the downstream end of the module in each trail was 32 psi. Permeate flux reported in Table 1 is the average flux, in liters per square meter per hour (Lmh), over the first 5 minutes of operation. No air was observed permeating through the membranes 16 in any of the trials.

TABLE 1

| | Micro-bubbles in | Vortex | | Permeate flux |
|---|---|---|---|---|
| Trial # | Saturation Tank | generator | Bulk air | (Lmh) |
| 1 | No | No | No | 48.4 |
| 2 | Yes | No | No | 57.9 |
| 3 | No | Yes | No | 54.1 |
| 4 | Yes | Yes | Yes | 98.6 |
| 5 | No | Yes | Yes | 97.1 |

As shown in Table 1, adding micro-bubbles in the saturation tank in trial 2 improved flux by about 20% relative to trial 1. Adding vortex generators in trial 3 improved flux by about 12% relative to trial 1. However, adding vortex generators and bulk air in trials 4 and 5 improved flux by about 100% relative to trial 1. Although the micro-bubble generator was not used in trial 4, it is believed that micro-bubbles still developed in the system with at least some attachment to solid particles. A 500 mL beaker was filled with wastewater withdrawn from the recirculation loop downstream of the air relief vessel 96 during trial 4. A thick layer of floc formed on the surface of the sample, and the wastewater below the floc layer became clearer, within 25 seconds. In contrast, a sample of wastewater drawn from a trial where the microbubble generator was not fed with air and bulk air was not mixed with the feed water. No floc layer formed in this same after 5 minutes. These results indicate that at least some micro-bubbles and solid-bubble aggregates were created in trial 4 despite the lack of the micro-bubble generator.

Two additional trials were run generally as described above but with a different wastewater as the feed water 50 and with the fourth system 160 configured as described in Table 2 below. The wastewater 50 had a TSS of 519 ppm and 45 ppm of oil and grease. As shown in Table 2, adding the vortex generators in trial 7 produced an increase in permeate flux relative to trial 6.

TABLE 2

| | Micro-bubbles in | Vortex | | Permeate flux |
|---|---|---|---|---|
| Trial # | Saturation Tank | generator | Bulk air | (Lmh) |
| 6 | No | No | Yes | 60.6 |
| 7 | No | Yes | Yes | 72.4 |

We claim:

1. A tubular membrane module comprising, a first potting head;
a second potting head;
a plurality of tubular membranes sealed in and extending between the potting heads;
a housing around the potting heads and the tubular membranes;
a spacer outside of one of the potting heads, the spacer comprising a plurality of bores; and,
vortex generators in the bores of the spacers.

2. The module of claim 1 wherein the vortex generators comprise a twisted tape twisted through at least 3 full rotations, or through between 3 and 15 or 3-10 full rotations.

3. The module of claim 1 wherein the spacer has a thickness in the range of 50-200 mm and the vortex generators have a length in the range of 50-300 or 50-250 mm.

4. The module of claim 1 wherein the length of the vortex generators does not exceed the thickness of the spacer.

5. The module of claim 1 wherein the vortex generators comprise a twisted tape and the width of the twisted tape is in a range of 20-100% or 25-75% of an outside diameter of the vortex generators.

6. The module of claim 1 further comprising a cap attached to the spacer, wherein the cap has two inlets.

7. The module of claim 6 the cap has an upper inlet and a lower inlet, and a baffle inside the cap vertically separating the upper inlet and the lower inlet.

8. The module of claim 6 wherein the lower inlet is in communication with a multiple port nozzle inside of the cap.

9. The module of claim 6 wherein one of the two inlets is connected to a source of feed water and air and the other of the two inlets is connected to a source of recirculating retentate.

10. The module of claim 6 wherein the source of feed water and air is connected to the lower inlet.

11. A system of membrane filtration comprising,
a vertically oriented tubular membrane module having a plurality of tubular membranes;
a liquid pump in communication with a feed inlet of the tubular membrane module;
an air compressor in communication with the feed inlet of the tubular membrane module; and,
vortex generators in communication with upstream ends of the tubular membranes.

12. The system of claim 11 wherein the vortex generators are mounted in a spacer associated with the tubular membrane module.

13. The system of claim 11 comprising a second liquid pump in a retentate recirculation loop connected to a second feed inlet of the membrane module.

14. The system claim 11 wherein air is added to feed water upsteam of feed water mixing with recirculating retentate.

15. The system of claim 11 have a plurality of tubular membranes connected in parallel with the feed pump with one or more of: at least four parallel branches; the membrane modules in each parallel branch less than 5 m long; feed water added at the top of the parallel branches; and, the system having a retentate recirculation loop.

16. A process of membrane filtration comprising,
adding a gas to a flow of liquid thereby creating a two-phase stream with the liquid as a continuous phase;
passing the two-phase stream through a vortex generator and through the lumen of a vertically oriented tubular membrane module,
thereby producing a rotating annular layer of the two-phase stream with the liquid as the continuous phase moving over an inner surface of the tubular membrane with a continuous gas phase inside of the annular layer along at least a portion of the length of the tubular membrane.

17. The process of claim 16 wherein the portion is at least 50% of the length of the tubular membrane.

18. The process of claim 16 comprising adding a flocculant to the feed liquid before adding the gas to the feed liquid.

19. The process of claim 16 comprising adding microbubbles to the feed liquid or otherwise forming aggregates of bubbles and solid particles in the feed liquid.

20. The process of claim 16 comprising one or more of: feeding gas and liquid to the membranes in a volumetric flow rate ratio between 3:1 and 1:3; providing a ratio of feed water flow rate to recirculating retentate flow rate in a range of 1:10 to 1:50; providing an axial velocity of liquid in the membranes may be in a range of 0.5-4 m/s; providing a tangential velocity of water in the membranes in the range of 1-16 m/s; and, providing a pressure inside the membranes in the range of 25-45 psi.
